(19) United States
(12) Patent Application Publication
(10) Pub. No.: US 2016/0239825 A1
(43) Pub. Date: Aug. 18, 2016

(54) System and Method for Determining a Secured Resource Account Number

(71) Applicant: Gopal Nandakumar, San Antonio, TX (US)

(72) Inventor: Gopal Nandakumar, San Antonio, TX (US)

(21) Appl. No.: 15/044,318

(22) Filed: Feb. 16, 2016

Related U.S. Application Data
(60) Provisional application No. 62/117,123, filed on Feb. 17, 2015.

(51) Int. Cl. G06Q 20/32; G06Q 20/40; G06Q 20/36

(52) U.S. Cl. CPC G06Q 20/3227; G06Q 20/3674; G06Q 20/401; G06Q 2220/00

(57) ABSTRACT

The present invention involves applications transacting on secured resource accounts such as financial accounts, and, generally comprises a means for secured resource transaction application to determine a secured resource originator using a dummy token in order to determine the actual secured resource within the secured resource originator using a single use authentication code.

### CROSS REFERENCE TO RELATED APPLICATIONS

This original application claims priority to and the benefit of U.S. provisional application Ser. No. 62/117,123, filed Feb. 17, 2015, which is incorporated by reference.

### STATEMENT REGARDING FEDERALLY SPONSORED RESEARCH OR DEVELOPMENT

Not applicable.

### BACKGROUND OF THE INVENTION

1. Field of the Invention

The present invention relates to applications that execute transactions on secured resources, such as financial accounts. Examples of transactions are credit card transactions and bank account transactions, etc.

2. Description of the Related Art

Accepting credit/debit cards is an essential part of any business, because it provides unique convenience for consumers and merchants. Consumers do not have to carry cash, can make a single payment, and set up budgets etc. This would translate into increased sales for merchants. At the same time accepting credit cards securely is important in order to combat credit/debit card fraud. Merchants use computer applications that execute transactions on credit/debit card accounts. Unless these applications able to protect themselves against man in the middle attackers, credit/debit card fraud cannot be stopped.

Credit cards are a form of revolving loan by where the card holder can access a line of credit to make purchases, cash advances, or balance transfers. As the outstanding balance is paid, the available credit line is restored for use again.

Card holder is an individual to whom a credit card is issued. Typically, this individual is also responsible for payment of all charges made to that card. Corporate cards are an exception to this rule. Card holder is also referred as end user.

Card issuer is an institution that issues credit cards to cardholders. This institution is also responsible for billing the cardholder for charges. Card issuer is also known as originator of the card account.

Merchant/Accepter is an individual, organization, or corporation that accepts credit cards as payment for merchandise or services.

Credit Limit is the amount of credit made available for the card holder to use.

Billing Cycle is the date that card holder's statement is produced every month. The payment due date is a number of days later from billing date.

Personal Identification Number (PIN) is the number used to access their account to get cash at an ATM machine or make other PIN verified transactions. A number automatically generated by the computer, then sealed and sent to the cardholder.

Debit cards are a form of prepaid cards where the cardholder can access balances from a bank account to make purchases, cash advances, or balance transfers.

Merchant Credit cards are a form of revolving loan by where the cardholder can access a line of credit to make purchases from a single merchant with whom the line of credit was established. As the outstanding balance is paid, the available credit line is restored for use again.

In any credit or debit card transactions the most important aspects are establishing a standard procedure in assigning numbers to cards and establishing a standard procedure to fully authenticate that any transaction requesting access to the account is generated by the legitimate holder of the card.

In any credit or debit card transactions one of the most important aspect is establishing a standard procedure in assigning numbers to cards. A valid credit/debit card number (also known as Primary Account Number—PAN) has several fields and each of them has a meaning. For the technically inclined, this number complies with the ISO/IEC 7812 numbering standard. A valid credit/debit card number contains a six-digit issuer identification number (IIN), an individual account identification number, and a single digit checksum. The first digit of the issuer identification number is the major industry identifier (MII). It identifies the industry where the card will be most used in. For example, ‘3’ is used by American Express or Diners Club or JCB, ‘4’ is used by Visa, ‘5’ is used by Mastercard and ‘6’ is used by Discover. If this digit is 9 the next three digits are the country code from ISO 3166-1. The issuer identification number also known as the bank identification number (BIN) is the first six digits of the credit card number. These identify the institution that issued the credit card to the card holder. Afterwards comes the account number, digit 7 to last minus one. The maximum length of the account number is 12 digits. This is an individual account identifier. The last digit is the checksum which is calculated using the MOD 10 algorithm. It is used to validate the primary account number to protect against accidental errors.

In any financial (bank) account transactions one of the most important aspect is establishing a standard procedure in assigning numbers to checks and/or with drawl vouchers. The numbering system has several fields and each of them has a meaning. A valid bank account number (also referred to here as Primary Account Number—PAN) contains a nine digit bank routing number (also referred here as Bank Identification Number) and an individual account number.

In any credit or debit card one of the most important aspect is letting merchants/accepters to process credit/debit card transactions securely online, offline, in-app and over the phone purchases. Card holders simply present their credit/debit card and merchants/accepters, without definitely knowing the real owner of the card, submit the transactions thru a payment terminal which could be a credit card terminal or a point of sale terminal or thru a virtual terminal. Credit card terminal or point of sale terminal in addition to accepting data thru a key pad and thru a magnetic strip reader can also support to accepting data using contact less interface. The contact less interface requires NFC reader or a RFID reader or a Bluetooth reader or a QR Code Scanner. The payment terminal would route the transaction to the appropriate card issuer based on the BIN which is the first 6 digits of the card number. The terminal would also verify the last digit is based on MOD 10 algorithm. In addition to credit/debit card number the terminal would also send expiration date, account holders name, and a card verification code (CVC) or personal identification number. Over the years credit/debit card processing have gone thru several transformations, but most of them happened only in recent years.

In the beginning card numbers were embossed on the card so that an impression can be made on a piece of paper and approval was obtained using a toll free telephone number. The verification is done by physically comparing the signature on the back of the card with the signature on a driver's license. Later to expedite the process and to improve security, card numbers were printed on the card as well as stored in magnetic stripe on the card. With the advent of magnetic stripe, merchants/accepters were able to use terminals to submit transactions electronically. Any man in the middle hacker can intercept the transaction sent from merchant/accepter to the card issuer and use them without card owner's knowledge. Also the card has a security code printed on front or back of the card, not saved in the magnetic strip. The consumer or the merchant enters the security code and also transmitted along with the card number. The card issuer would verify the security code in addition to verifying the card number. Because of high incidences of credit/debit card fraud card issuers introduced encryption technology, especially, end to end, meaning that the data is encrypted even before it leaves merchants' terminals and is not decrypted until it reaches the card issuer. Even though this seemed to be a hack free method, unfortunately the credit/debit card fraud could not be stopped. Card issuers joined together and formed an alliance known as Payment Card Industry (PCI) to develop standards in protecting card information and to enforce that the standards are followed by merchants, software developers, equipment manufacturers, processors, acquirers and card issuers. Because even this stringent method did not stop the credit/debit card theft, some of the Payment Card Industry members (Europay, MasterCard and Visa) formed an alliance known as EMVCo. to develop standards for chip based cards instead of magnetic stripe based cards known as smart chip. With the advent of mobile payment, card numbers or a software version of smart chip were also be able to save in mobile devices. Saving a software version of smart chip in mobile devices is called as Host Card Emulation. Recently, EMVCo has also introduced tokenization where at least a single token will be created for each primary account number and the token will be transmitted instead of the primary account number. The tokenization introduced new set of players, namely token service providers and token requestors. Multiple tokens can be issued to the same primary account number based on the interface being used by the merchant/accepter. The common interfaces are face to face, online, in-app and over the phone etc. Tokens are not Primary Account Numbers but can be used by the card issuer to get the primary account number with the help of a token issuer. The BINs of primary account number and its tokens must be same and tokens cannot be used as primary account numbers. Tokens can only be used to get primary account number. Tokens can only be issued by token service providers. Token service providers can be card issuers or any third party approved by card issuers. Along with token, EMVCo specification on tokenization also included Single Use Tokens that is wrapped inside a cryptogram that can be decrypted by token issuer. Single Use Tokens is simply used to verify that the transaction is not tampered during transmission. The reason behind using tokens is to protect Primary Account Numbers. Still tokens are valuable to hackers and may be used to access Primary Account Numbers. So if a token is hacked, the token issuer simply inactivates the hacked token and issues a new token without the need to inactivating primary account number and issuing primary account numbers. The published document on EMVCo specification on tokenization can be downloaded at www.emvco.com->Home->Tokenization. The latest version is 1.0 and the publication data is March 2014. FIG. 1 is Payment Token Provisioning Overview and FIG. 2 is Payment Token Transaction Overview are copied from the downloaded document on EMVCo specification on tokenization.

Giving the fundamentally flawed state of the art with respect to applications transacting on secured resource account numbers, it is therefore the overriding object of the present invention to improve the prior art by providing a system and related method by which real account number can be determined only by using dummy token and a fully verifiable single use authentication code. Dummy token is used to determine the entity holding the secured resource account (example: card issuer or originator) and a single use authentication code is used to determine primary account number. Single use authentication code must be fully verified. Dummy tokens or the single use authentication codes do not have any value for hackers. Dummy token or the single use authentication code cannot be used one without the other. With the present invention the secured resource is not only protected from real resource account number, but also protected from real resource account number tokens. Even if the real account number or real account number tokens are compromised to man in the middle attackers, the real account number or real account number tokens are no value for such man in the middle attackers.

### BRIEF SUMMARY OF THE INVENTION

In accordance with the foregoing objects, the present invention—applications transacting on secured resource accounts such as financial accounts—generally comprises a means for secured resource transaction application to determine the secured resource originator using a dummy token and to determine the actual secured resource within the secured resource originator using a single use authentication code.

### BRIEF DESCRIPTION OF THE DRAWINGS

FIG. 1 is Payment Token Provisioning Overview copied from the document on EMVCo specification on tokenization.

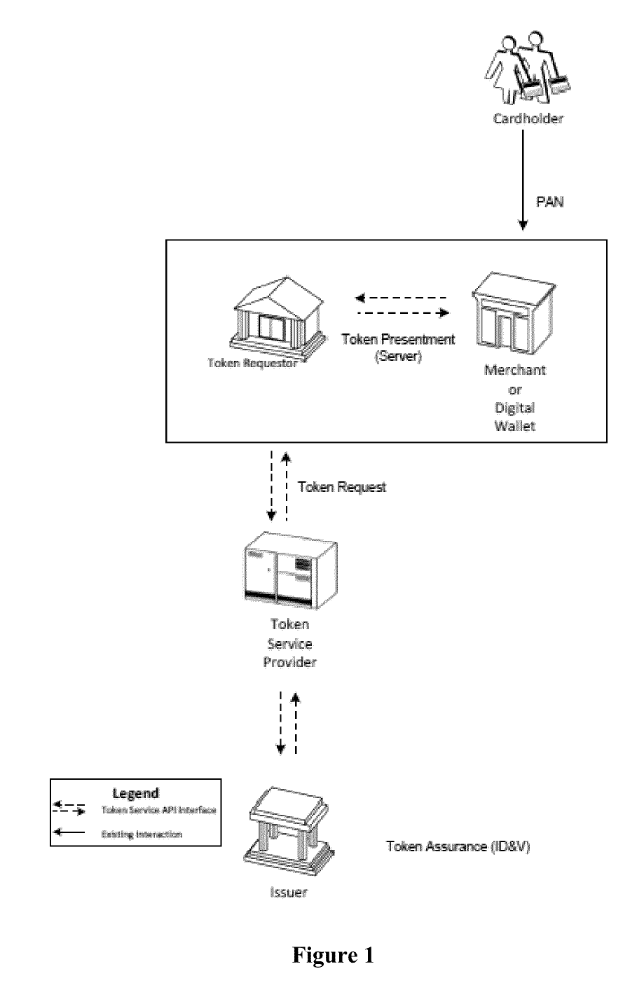

FIG. 2 is Payment Token Transaction Overview copied from the document on EMVCo specification on tokenization.

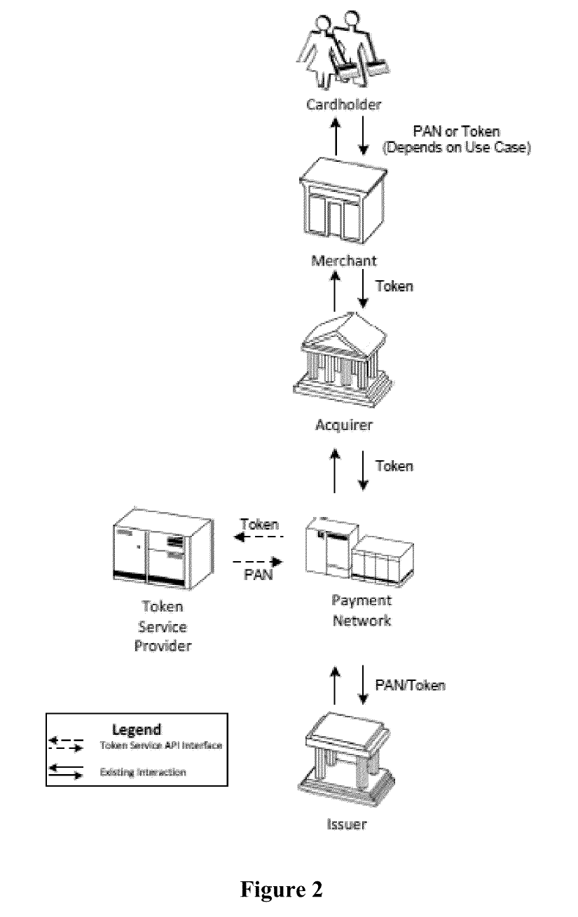

FIG. 3 shows, in an overview user case diagram, the various basic functionality implemented in the preferred embodiment of the secured resource transaction application system and method of the present invention.

FIG. 4 shows, in a flow chart, an overview of the various steps generally taken in providing a means in assigning a Token to primary account number in accordance with the present invention.

FIG. 5 shows, in a flow chart, an overview of the various steps generally taken in providing a means to populate Dummy Tokens in accordance with the present invention.

FIG. 6 shows, in a flow chart, an overview of the various steps generally taken in providing a means for an end user to receive a Challenge string from service provider.

FIG. 7 shows, in a flow chart, an overview of the various steps generally taken in providing a means for an end user to make a choice on how to provide credentials to service client.

FIG. 8 shows, in a flow chart, an overview of the various steps generally taken in providing a means for end user to provide authentication credentials electronically to service client and for service client to forward the credentials to secured resource transaction application and to receive results.

FIG. 9 shows, in a flow chart, an overview of the various steps generally taken in providing a means for end user to provide authentication credentials manually to service client and for service client to forward the credentials to secured resource transaction application and to receive results.

FIG. 10 shows, in a flow chart, an overview of the various steps generally taken in providing a means for end user to revoke authentication credentials.

FIG. 11 shows, in a class diagram, a high level schema for a representative end user table in a common online database as may be implemented in connection with the exemplary hardware and software implementation of FIG. 3.

FIG. 12 shows, in a class diagram, a high level schema for a representative end user credit card table in a common online database as may be implemented in connection with the exemplary hardware and software implementation of FIG. 3.

FIG. 13 shows, in a class diagram, a high level schema for a representative service client table in a common online database as may be implemented in connection with the exemplary hardware and software implementation of FIG. 3.

FIG. 14 shows, in a class diagram, a high level schema for a representative dummy token table in a common online database as may be implemented in connection with the exemplary hardware and software implementation of FIG. 3.

FIG. 15 shows, in a class diagram, a high level schema for a representative Authentication Credential table in a common online database as may be implemented in connection with the exemplary hardware and software implementation of FIG. 3.

FIG. 16 shows, in a class diagram, a high level schema for a representative end user credit card table in a local database, which could be used when common online database is not available for the service provider, as may be implemented in connection with the exemplary hardware and software implementation of FIG. 3.

FIG. 17 shows, in a class diagram, a high level schema for a representative service client table in a local database, which could be used when common online database is not available for the service provider, as may be implemented in connection with the exemplary hardware and software implementation of FIG. 3.

FIG. 18 shows, in a class diagram, a high level schema for a representative Dummy Token table in a local database, which could be used when common online database is not available for the service provider, as may be implemented in connection with the exemplary hardware and software implementation of FIG. 3.

FIG. 19 shows, in a class diagram, a high level schema for a representative Authentication Credential table in a local database, which could be used when common online database is not available for the service provider, as may be implemented in connection with the exemplary hardware and software implementation of FIG. 3.

FIG. 20 shows, in a class diagram, a high level schema for a representative Dummy Token Table in Token Service Provider Database.

FIG. 21 shows, in a class diagram, a high level schema for a representative Primary Account Number Token Table in Token Service Provider Database.

### DETAILED DESCRIPTION

For the sake of clarity present invention would be referred as advanced credit/debit card transaction application.

Just like with traditional credit/debit card transaction application, the card number used in the advanced credit/debit card transaction application follows the standard format namely 6 digit bin (BIN), up to 12 digits account number and one digit checksum. With traditional credit/debit card transaction application the card number may be a primary account number or be a token attached to a primary account number. With advanced credit/debit card transaction application the card number is neither a primary account number nor a token attached to a primary account number.

Just like with traditional credit/debit card transaction application, the advanced credit/debit card transaction application also uses expiration month and year.

Just like with traditional credit/debit card transaction application, the advanced credit/debit card transaction application also uses a security code.

For card present transactions, traditional credit/debit card transaction application retrieves the security code from magnetic strip or from chip card or from smart card. For card not present transactions, traditional credit/debit card transaction application lets the card holder to enter the security code copied from the one printed on the card. For all transactions the advanced credit/debit card transaction application receives electronically from the card holder or lets the card holder to enter a single use authentication code. The card holder might have received the single use authentication code from a service provider or might be a response by the card holder to a challenge received from the service provider. The advanced credit/debit card transaction application uses single use authentication code as the security code. The advanced credit/debit card transaction application, using services of the service provider, receive a token to the primary account number in exchange for the single use authentication code.

While the foregoing examples of using Dummy Tokens and single use authentication code is exemplary of the preferred embodiment of the present invention, those of ordinary skill in the relevant arts will recognize that many variations, alternations, modifications, substitutions, and the likes in using Dummy Tokens and Single Use Authentication Code are readily possible.

Although those of ordinary skill in the art will readily recognize many alternative embodiments, especially in light of the illustrations provided herein, this detailed description is exemplary of the preferred embodiment of the present invention, the scope of which is limited only by the claims appended hereto:

More particularly the invention relates to a system and related method whereby a secured resource account number can be determined by computer applications accessing said secured resources, by using a single use authentication string received from a requestor that was provided to the requester by requester's client and was generated by requester's client with the help of a service provider which assigned a single use linkage between the single use authentication string with the real account number.

Furthermore the invention also relates to a system and related method whereby the said computer applications also received an account number, purports to be a real account number for man in the middle attackers and is not assigned to any real account, received from the requestor that was provided to the requestor by requestor's client and was provided to requestor's client by a service provider. The account number will be used by the said computer applications only to identify the originator of the said secured resources and not the actual account numbers.

Furthermore the invention also relates to a system and related method whereby the single use authentication string that provided the single use linkage between the single use authentication string and the real account number was generated by a service provider or was generated by the requestor's client as a response to a challenge string provided by the service provider. When the single use authentication string was generated by the requestor's client as a response to a challenge string, the procedure used by the requestor's client to generate the response string is pre-determined and known to both requestor's client and the service provider.

Furthermore the invention also relates to a system and related method whereby the single use authentication string that provided the single use linkage between the single use authentication string and the real account number was selected by the service provider from a set of single use authentication strings previously saved in a local database because communication with online database is not available for the service provider.

Furthermore the invention also relates to a system and related method whereby the single use authentication string that provided the single use linkage between the single use authentication string and the real account number was generated by the requester's client as a response to a challenge string provided by the service provider was selected by the service provider from a set of previously saved single use challenge strings in a local database because communication with online database is not available for the service provider.

The single use authentication string is also referred as single use authentication code.

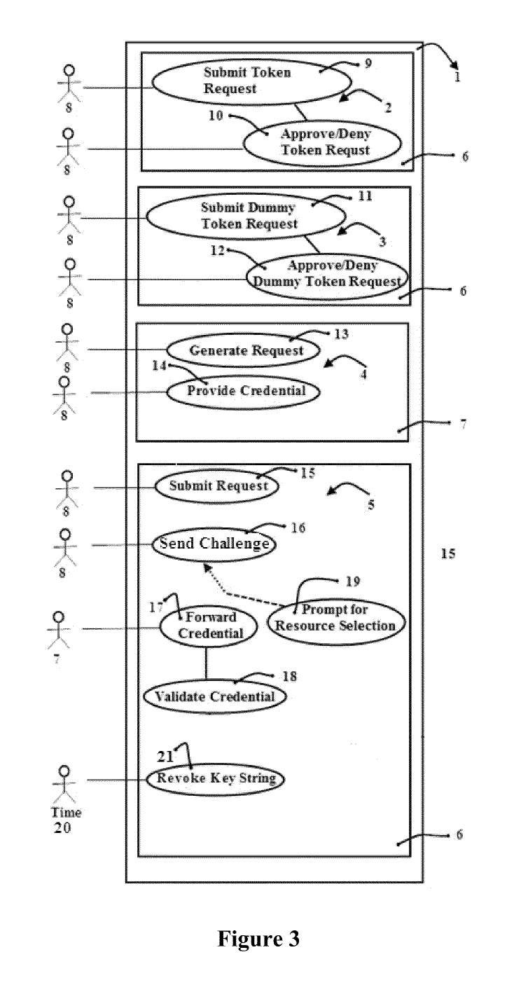

Referring now to the figures, and to FIG. 3 in particular the secured resource access system 1 of the present invention is shown to generally comprise an operative combination of a plurality of service provider 6 implemented use cases 2 to maintain tokens and implemented use cases 3 to maintain dummy tokens, a plurality of service client 7 implemented use cases 4 to identify the service client to service provider by end user 8 and to receive credentials from end user 8 and plurality of service provider 6 implemented use cases 5 to receive request form end user 8, send challenge to end user 8, forward credential to service client 7, validate and revoke credential for transaction applications that use secured resource.

As also shown in FIG. 3, the service provider 6 of the present invention will generally provide a means 9 for end user actor 8 to submit details of financial accounts and a means 10 to generate tokens for financial accounts. The service provider 6 of the present invention will generally provide a means 11 for end user actor 8 to submit details of a financial accounts and a means 12 to generate dummy tokens for financial account locations. The service client 7 of the present invention will generally provide for an end user actor 8 a means 13 for identifying the service client 7 to a service provider 6 for the purpose of requesting that the service provider 6 provide for the service client 7 access to a secured resource. Additionally, the service client 7 of the present invention will generally provide for an end user actor 8 a means 14 for submitting an authentication credential to the service client 7 for use by the service client 7 in obtaining from the service provider 6 access to the requested secured resource.

As also particularly shown in FIG. 3 the service provider 6 of the present invention will generally provide for an end user actor 8 a means 15 for requesting, that access to a secured resource be provided by the service provider 6 for a service client 7. Additionally, the service provider 6 of the present invention will generally provide responsive to the submission by an end user actor 8 of a request for access to a secured resource a means 16 for generating and sending to the end user actor 8 a challenge message designed to enable only the intended end user actor 8 to determine the content of a transient authentication credential. Further, the service provider 6 of the present invention will generally provide for a service client actor 7 a means 17 for forwarding an end user 8 provided authentication credential to card issuer and then to service provider. Still further, the service provider 6 of the present invention will generally provide responsive to the forwarding by service client actor 7 of an authentication credential a means 18 for validating the authentication credential and provide a token to a primary account to the card issuer.

In an extension of the present invention particularly useful in implementations wherein the service provider 6 may not otherwise be readily able to determine the identity of a resource to which the end user actor 8 requests access based on the information content of the request as initially submitted by end user actor 8 to the service provider 6, the service provider 6 may in combination with the means 15 for requesting access to a secured resource also be adapted to provide a means for determining a particular resource for access on the authority of the end user actor 8 such as, for example, a means 19 for prompting the end user actor 8 to provide additional identifying information for the requested resource.

Finally, it is noted that Time 20 as an actor may be accommodated as desired in any particular implementation wherein the service provider 6 is also provided with a means 21 responsive to the passage of time for revoking or otherwise invalidating an authentication credential such that an authentication credential otherwise correctly provided by an end user actor 8 to a service client 7 and forwarded to the service provider 6 may as a result of passage of time be deemed to be incorrect, thereby resulting in validation failure upon application of the means 18 for validating the authentication credential.

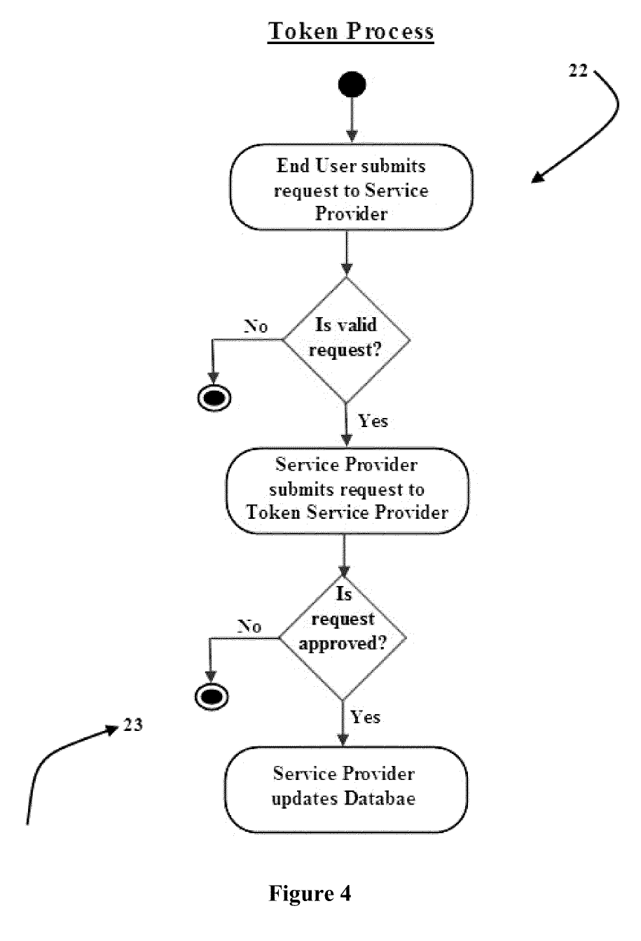

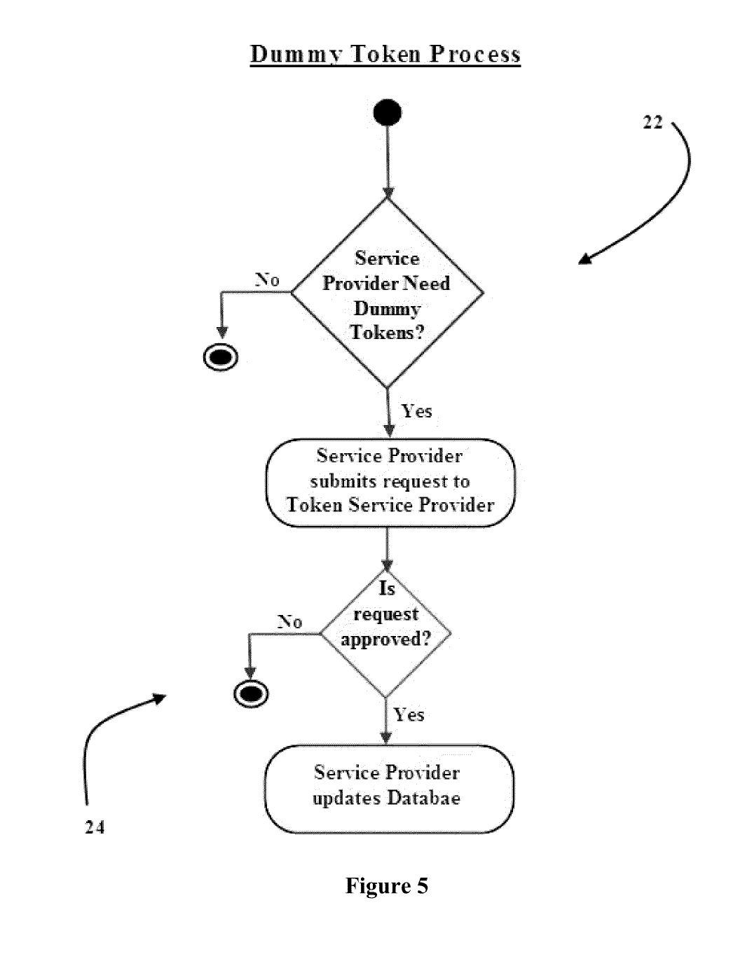

Referring now then to FIGS. 4 and 5 in particular, the token method 22 of the present invention as operative upon the described authentication system 1 is shown generally comprise various series of interactions between and end user 8, a token system 2 and a dummy token system 3, as step 23 implicated in maintaining tokens as broadly set out in FIG. 4, and step 24 implicated in maintaining dummy tokens as broadly set out in FIG. 5.

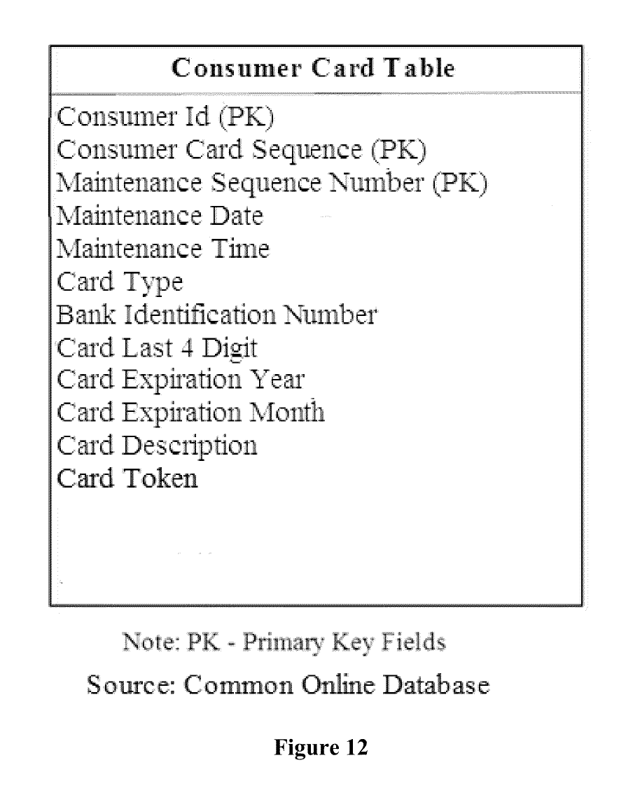

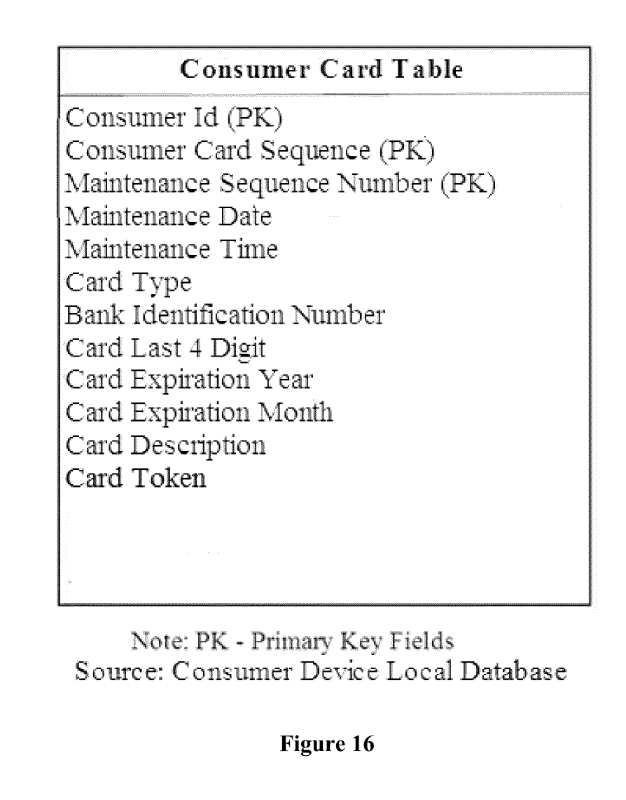

As particularly shown in FIG. 4 the token method 22 of the present invention generally begins with an end user 8 submitting a request for a token thru service provider 6 to token service provider. Token service providers can provide tokens for primary account numbers. The data or other information submitted by end user 8 will generally comprise the primary account number (credit/debit card number assigned to end user 8 by card issuer (bank)), expiration date, card holder name, and security code etc. Service provider 6 would then submit the request to token service provider. The token value can be determined either by the service provider 6 or by the token service provider. In any case the token value must be unique for each primary account number issued by the same card issuer, will not be another primary account number and need not be in same format as primary account number. For example the service provider 6 can determine the token value by using end user (consumer) id plus a unique sequence number assigned to the primary account number by the service provider 6. If the token value is determined by the service provider 6, then the data or other information submitted by the service provider 6 would also include the token value. In any case, if the token request from end user 8 submitted thru service provider 6 is approved, then the token will be saved by service provider 6 as well as by token service provider. Upon approval of the request, the service provider 6 would receive the value of the token. But service provider 6 will never save the primary account number. So using the token, the token service provider can determine the primary account number, but service provider 6 can never determine the primary account number using the token. The service provider 6 can save a descriptive string to identify the primary account number and the descriptive string will not be primary account number. The descriptive string will be used by the service provider 6 as a string displayed to the end user 8 to enable the end user 8 to select a single primary account number, without actually viewing the primary account number, from a plurality of descriptive strings. Furthermore, for security reasons, the token service provider will never accept the value of a token as an input for any functions. The token service provider would only use the services of service provider 6 to receive the value of the token and then determine the primary account number from the value of the token. In any case the token value will be saved in Consumer Card Table in common online database as well as in local database as shown in FIGS. 12 and 16 respectively.

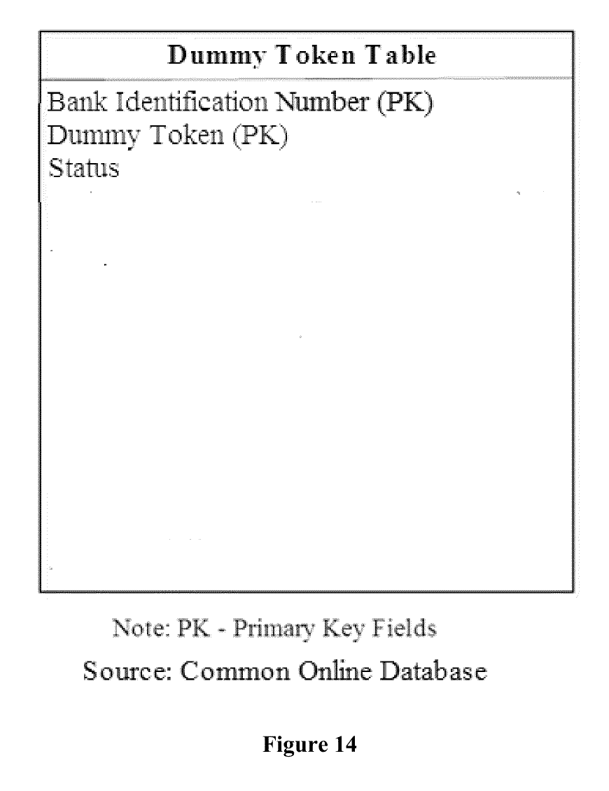

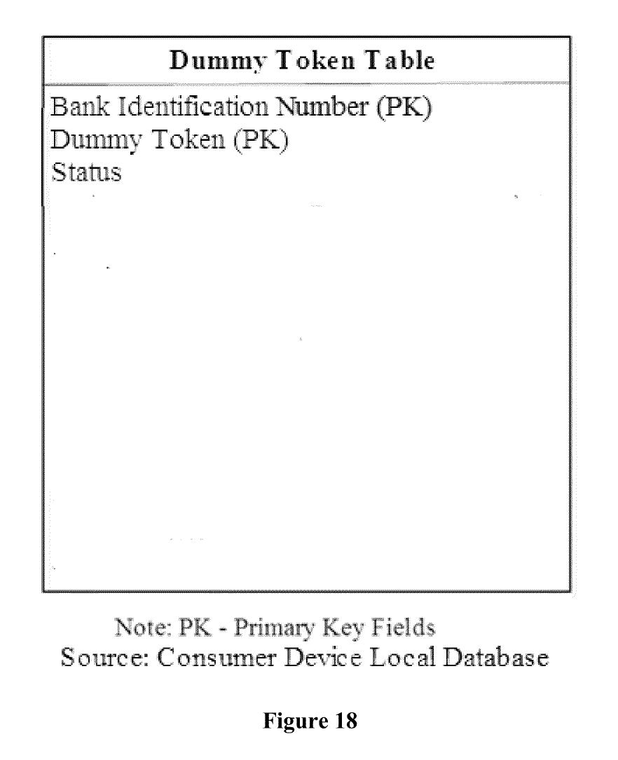

As particularly shown in FIG. 5 the token method 22 of the present invention generally begins with a service provider 6 submitting a request for a dummy token to token service provider. Token service providers can also provide dummy tokens in addition to tokens. Dummy tokens have the same format as primary account numbers, but are not tied to any primary account numbers but only tied to first 6 digits of the primary account number known as BIN. Dummy tokens can only be used to determine the card issuer of a primary account number and not to determine any primary account number. Dummy tokens are not required for each individual primary account number, but required at least one dummy token for an unlimited number of primary account numbers issued by the same card issuer under the same BIN. Dummy tokens cannot be primary account numbers. The first 6 digits of dummy token should be same as first 6 digits of primary account numbers that are issued by the same card issuer under the same BIN. The data or other information submitted by service provider 6 will generally comprise BIN (bank identification number). If the dummy token request from service provider 6 is approved, then the dummy token will be saved by service provider 6 as well as by token service provider. Card issuer will never assign the value of any dummy token as primary account number. Dummy tokens will be used by the service provider 6 when response message from end user 8 is used by service client 7. Dummy token will be used as primary account number in the transaction submitted by service clients. In any case, if dummy token request from service provider 6 is approved, then the dummy token will be saved by service provider 6 as well as by token service provider. The dummy token value will be saved by the service provider in Dummy Token Table in common online database as well as in local database as shown in FIGS. 14 and 18 respectively.

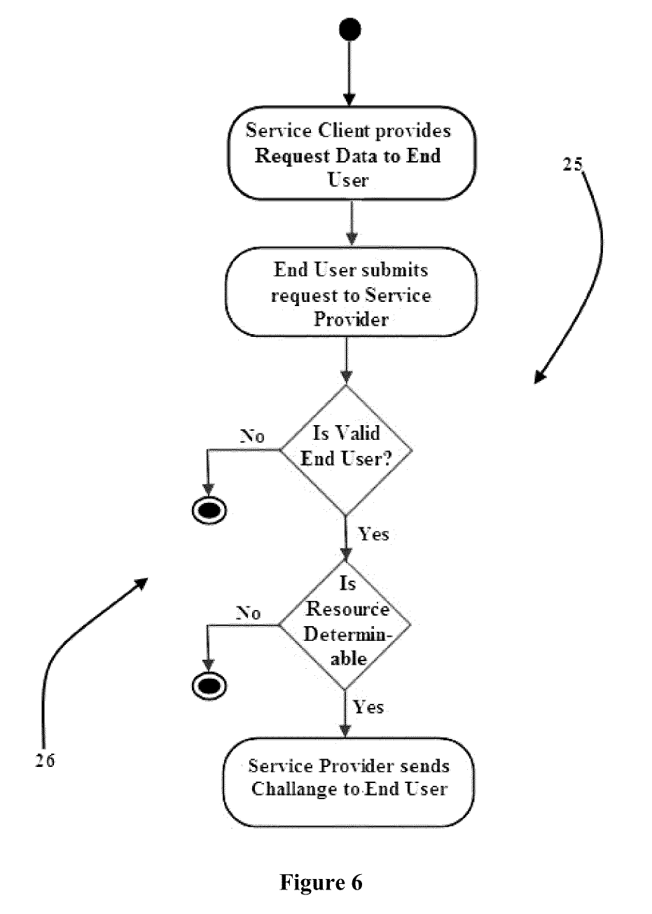

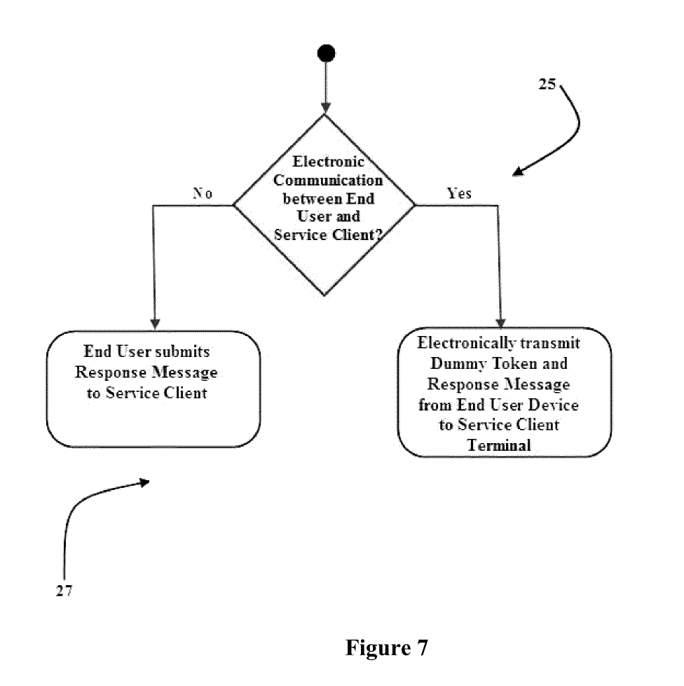

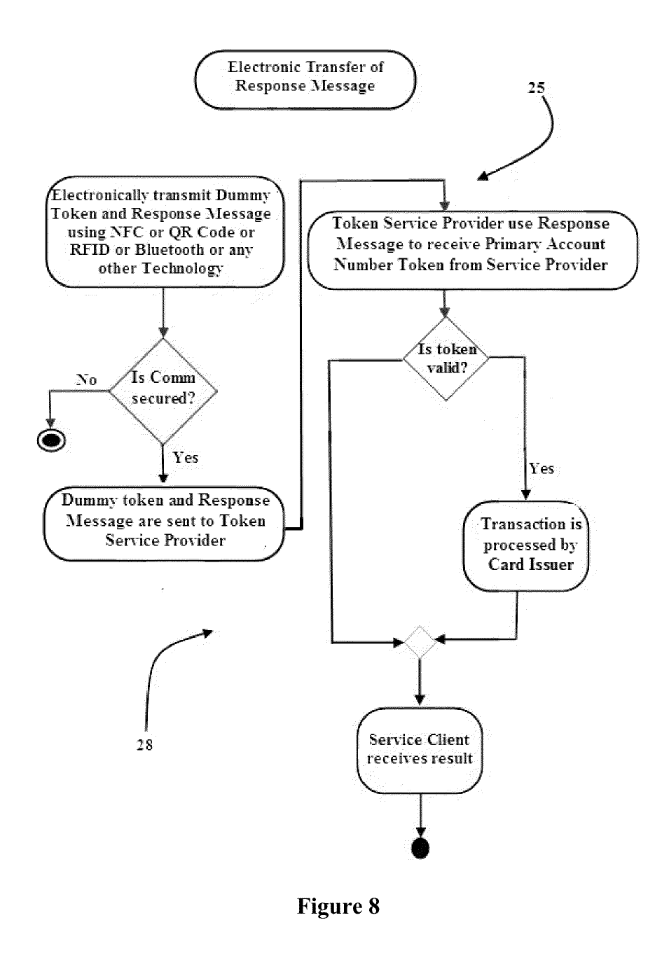

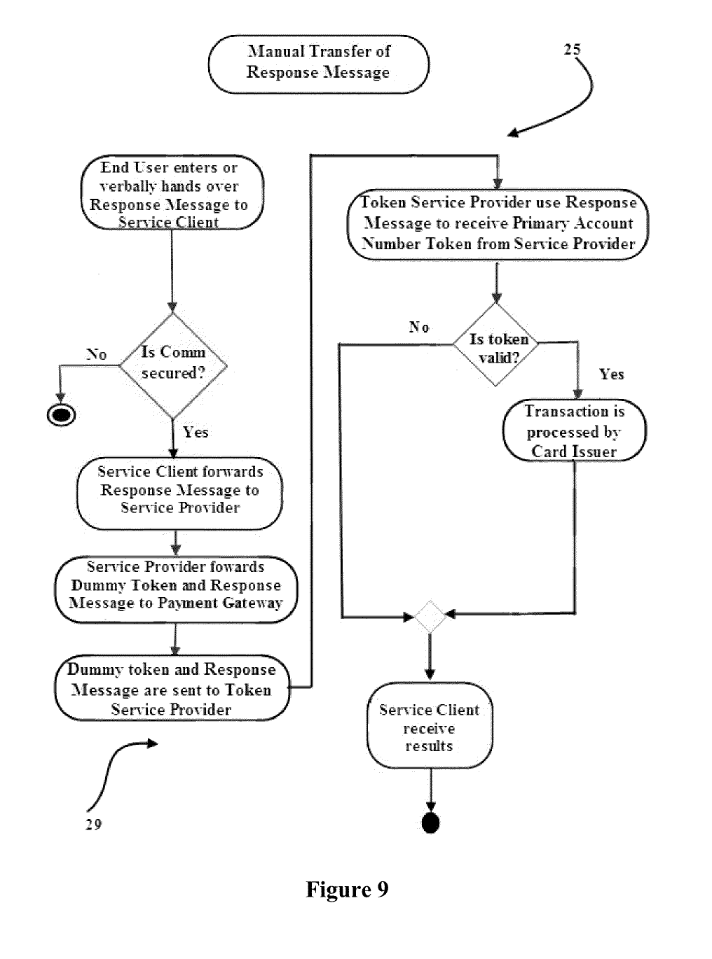

Referring now then to FIGS. 6 through 9 in particular, the authentication method 25 of the present invention as operative upon the described authentication system 1 is shown to generally comprise various series of interactions between an end user 8, a service client system 4 and a service provider system 5, as step 26 implicated in requesting access to a secured resource, as broadly set out in FIG. 6, as step 27 implicated in determining an interface as broadly set out in FIG. 7, as step 28 implicated in using an electronic interface in validating the purported access right of the user requesting access to the secured resource, as broadly set out in FIG. 8 and as step 29 implicated in using an manual interface in validating the purported access right of the user requesting access to the secured resource, as broadly set out in FIG. 9.

As particularly shown in FIGS. 6-9, the authentication method 25 of the present invention generally begins with an end user 8 obtaining from a service client 7 data or other information necessary for the end user 8 to request that a service provider 6 provide for the service client 7 access to a secured resource. The data or other information will generally comprise the identification of the service client 7, but may additionally comprise any other data or information as may be helpful for the conduct of a particular transaction such as, for example, a purchase amount, a client reference, detailed or itemized transaction data or the like. In any case, the service client provided information is then utilized by the end user 8 to submit a request message to the service provider 6 for the service provider 6 to provide for the service client 7 access to a secured resource.

Referring now then to FIG. 6, once a submitted request message is received by the service provider 6, the service provider 6 preferably determines whether the end user 8 making the request is authorized or otherwise permitted to make such use of the authentication system 1. If, in an implementation of this feature, it is determined that the end user 8 is not authorized or otherwise permitted to make the attempted use of the authentication system 1 the step 26 will generally terminate whereas if it is determined that the end user 8 is authorized or otherwise permitted to make the attempted use of the authentication system 1, the step 26 will generally continue. Continuing in an important step, the service provider 6 must be able to evaluate the request message to determine the specific identity of the resource for which the request is made. If the available and/or obtainable information is insufficient for the service provider 6 to positively determine the identity of the resource for which the end user 8 has requested access the step 26 will generally terminate whereas if the available and/or obtainable information is sufficient for the service provider 6 to positively determine the identity of the resource for which the end user 8 has requested access the step 26 will generally continue.

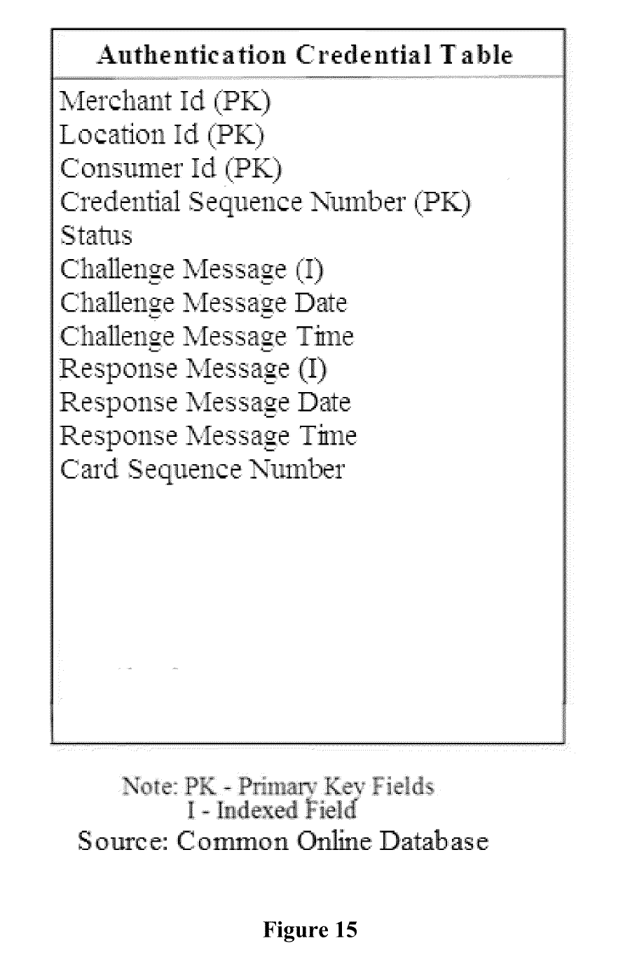

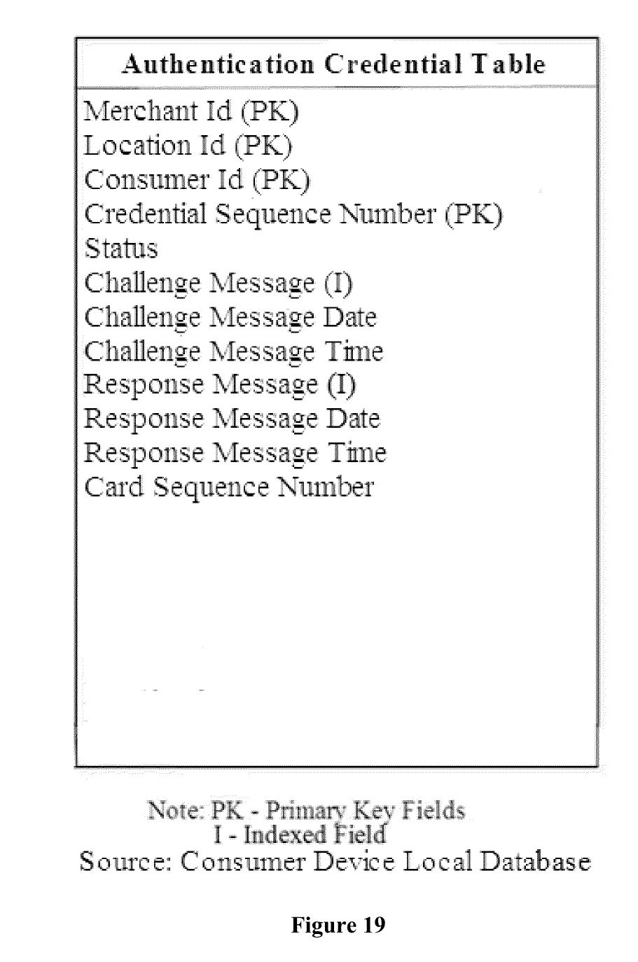

In the final steps of processing a request for access to a secured resource, if the request is authorized and if the requested resource is specifically identifiable then the service provider 6 would generate a challenge message for use by the end user 8 and, thereafter, would send the challenge message to the end user 8, otherwise the service provider 6 would generate an error message and, thereafter, would send the error message to the end user 8. If a challenge message is generated by the service provider 6 and sent to the end user 8, then the challenge message will be saved by the service provider in Authentication Credential Table in common online database as well as in local database as shown in FIGS. 15 and 19 respectively.

With the challenge message issued by the service provider 6 to the end user 8, the end user 8 will then formulate and submit a response message to the service client 7. The end user 8 will use a procedure that is previously established and known to both end user 8 and the service provider 6 to create the response message based on the challenge message.

The procedure to create the challenge message can be anything that can be executed by any computer with or without using any data available for the end user 8 and/or the service provider 6. For example the procedure may be to use the challenge message itself as a response message or the challenge message may be message with blank or blanks where end user will fill in the blank or blanks with end user's personal identification number established with the service provider or the challenge message may be blank and the response message will be one or more specific information from the transaction and so on. There is no limit on how many procedures can be used and how they can be established.

In an implementation of this feature the procedure could be the authentication credential used in an authentication system used in claim number 1 in U.S. Pat. No. 8,505,079 or an authentication credential used in an authentication system used in claim number 1 or U.S. Pat. No. 8,533,802 or a response string used in an authentication system used in claim number 1 of U.S. Pat. No. 8,566,957 or a response message used in the method used in claim number 1 of U.S. Pat. No. 8,695,071 or a response string used in the method used in claim number 1 of U.S. Pat. No. 8,713,656 or a response string used in the method used in claim number 1 of U.S. Pat. No. 8,800,014 can be used as challenge message. Each of the above referenced patents is incorporated by reference herein.

In any case, once the end user 8 receive the challenge message from the service provider 6, the end user 8 would formulate a response message according to a procedure communicated to the end user 8. For example the end user may be asked to use the challenge message itself as response message or to fill in the blanks in the challenge message to fill in their own personal identification number and so on.

Referring now then to FIG. 7, once a response message is formulated by the end user 8, the end user 8 will be asked to forward the response message to the service client 7 using either manual interface or electronic interface based on the content in the request generated by the service client 7 to identify the service client 7 to the service provider 6 for the purpose of requesting that the service provider 6 provide the service client 7 access to a secured resource. Referring to FIG. 3 where the secured resource access system 1 of the present invention is shown generally comprise an operative combination of a plurality of service client 7 implemented use cases 4 and provided means 13 to generate the request. In an implementation of this feature the step 27 will generally determine the type of interface is either manual or electronic based on the content in the request generated by the service client 7 to identify the service client 7 to the service provider 6 for the purpose of requesting that the service provider 6 provide the service client 7 access to a secured resource. If the interface is manual then the end user 8 will be directed either to hand over the response message to the service client 7 either by entering the response message in a key pad or by verbally handing over the response message in person or over the phone or thru an email or thru a text message. If the interface is electronic then the end user 8 will be asked to place the mobile device near to an NFC reader or to place the mobile device near to a RFID reader or to place the mobile device near to a Bluetooth reader or to show the QR Code to the service client 7 so that the QR Code can be scanned by the service client 8. NFC device or RFID device or Bluetooth device can be pre-loaded by mobile device manufacturers or can be added. QR Code can be generated in any mobile device using QR Code generator software. In any case the end user 8 would forward the response message to the service client 7.

Referring now then to FIGS. 8 and 9 in particular, the authentication method 25 of the present invention as operative upon the described authentication system 1 is shown to generally comprise various series of interactions in service provider system 5, as step 28 implicated in processing the response message using an electronic interface, as broadly set out in FIG. 8, and step 29 implicated in processing the response message using a manual interface, as broadly set out in FIG. 9.

Referring now then to FIG. 8, a dummy token attached to the bank identification number of the specific resource for which the request is made along with the response message is forwarded by the end user 8 to the service client 7 using an electronic interface, the service client 7 would submit the payment transaction by populating card number field with the dummy token and security code field with response message. The transaction would be submitted to the card processing system which would in turn forward it to acquirer system which would in turn forward it to payment network system which would in turn forward it to token service provider before forwarding it card issuer. The token service provider, based on the value in the card number field would determine whether the value in the card number field is a valid dummy token. If it is in fact the value in the card number field is a valid dummy token then the token service provider would submit a transaction using the dummy token and the response message received from the end user 8 which was populated in the security code filed to the service provider 6 to receive the value of the token to determine the primary account number (PAN). The service provider 6 in turn would determine the value of the token based on the values received from the token service provider namely dummy token and response message. If the values of dummy token and response message are valid then the service provider 6 would return the value of the token to the token service provider. If values of dummy token and/or response message are not valid then the service provider 6 would return a blank to the token service provider. Upon receiving the return string from the service provider 6, the token service provider would determine the primary account number. If the value of the returned string from the service provider 6 is blank then the token service provider would use the dummy token as the primary account number. If the value of the returned from the service provider 6 is not blank then the token service provider would use the returned value as a token to determine the primary account number. If the token service provider could not determine the primary account number from the token then the token service provider would use the dummy token as the primary account number. If the token service provider could determine the primary account number then the token service provider would use the primary account number. Once the primary account number is determined the token service provider would replace the value in the field of the card number, which is the dummy token, with the primary account number. If the primary account number is same as the dummy token then the token service provider will not change the value in security code field. If the primary account is not same as the dummy token then the token service provider would replace the value in security code field with the security code of the primary account number. In any case, once the token service provider modified the values of the fields of card number and/or security code as needed then the transaction will be forwarded to the card issuer. Upon receipt of the transaction the card issuer would process the transaction. Upon completion of the processing of the transaction by the card issuer the results of the transaction will be sent back to the payment network system which in turn would forward the results of the transaction to the acquirer which in turn would forward the results of the transaction to the processor which in turn would forward the results of the transaction to the service client 7.

Referring now then to FIG. 9, once a response message is forwarded by the end user 8 to the service client 7 using manual interface, the service client 7 would submit the payment transaction without card number to the service provider 6. The service provider 6 then would determine the requester, the requested secured resource, bank identification number of the requested secured resource and then the dummy token and forward the payment transaction with card number field filled with the dummy token to a payment gateway which in turn would submit the payment transaction to a card processing system which would in turn forward it to acquirer system which would in turn forward it to payment network system which would in turn forward it to token service provider before forwarding it card issuer. The token service provider, based on the value in the card number field would determine whether the value in the card number field is a dummy token. If it is in fact the value in the card number field is a dummy token then the token service provider would submit a transaction using the dummy token and the response message received from the end user 8 which is populated in the security code filed to the service provider 6 to receive the value of the token to determine the primary account number (PAN). The service provider 6 in turn would determine the value of the token based on the values received from the token service provider namely dummy token and response message. If the values of dummy token and response message are valid then the service provider 6 would return the value of the token to the token service provider. If values of dummy token and/or response message are not valid then the service provider 6 would return a blank to the token service provider. Upon receiving the return string from the service provider 6, the token service provider would determine the primary account number. If the value of the returned string from the service provider 6 is blank then the token service provider would use the dummy token as the primary account number. If the value of the returned from the service provider 6 is not blank then the token service provider would use the returned value as a token to determine the primary account number. If the token service provider could not determine the primary account number from the token then the token service provider would use the dummy token as the primary account number. If the token service provider could determine the primary account number then the token service provider would use the primary account number. Once the primary account number is determined the token service provider would replace the value in the field of the card number, which is the dummy token, with the primary account number. If the primary account number is same as the dummy token then the token service provider will not change the value in security code field. If the primary account is not same as the dummy token then the token service provider would replace the value in security code field with the security code of the primary account number. In any case, once the token service provider modified the values in the fields of card number and/or security code as needed then the transaction will be forwarded to the card issuer. Upon receipt of the transaction the card issuer would process the transaction. Upon completion of the processing of the transaction by the card issuer the results of the transaction will be sent back to the payment network system which in turn would forward the results of the transaction to the acquirer which in turn would forward the results of the transaction to the processor which in turn would forward the results of the transaction to the payment gateway which in turn would forward the results of the transaction to the service provider 6 which in turn would forward the results of the transaction to the service client 7.

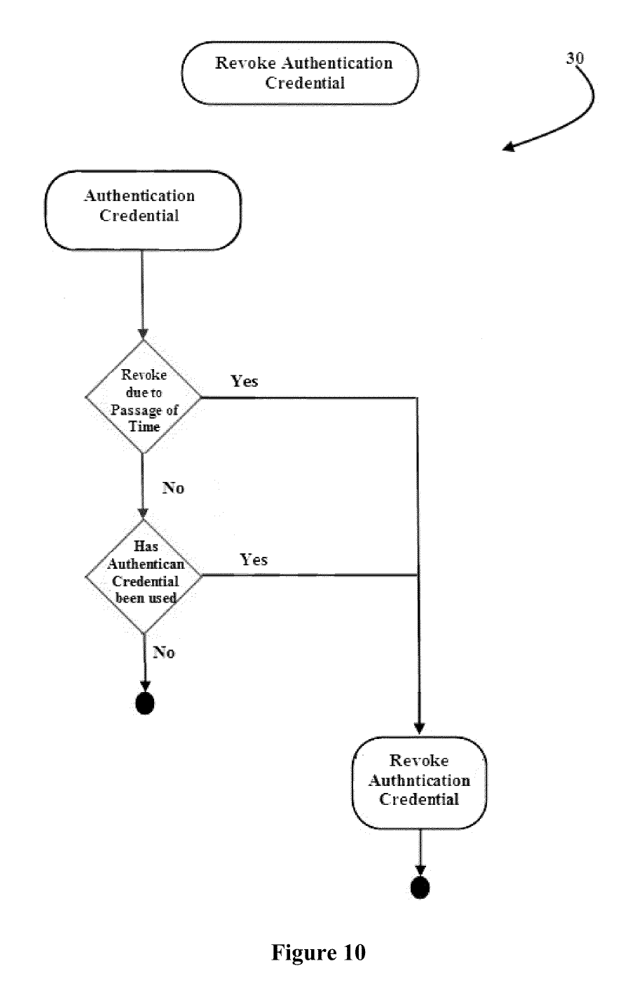

Finally referring to FIG. 10 in particular, the authentication method 25 of the present invention as operative upon the described authentication system 1 is shown to generally comprise a service provider system 5, as step 30 implicated in revoking authentication credential to access a secured resource, as broadly set out in FIG. 10. Once a response message which is also called as authentication credential has been used successfully, the service provider 6 would revoke or otherwise invalidate the authentication credential such that a repeat validation of the authentication credential with the same response message will be invalidated. Upon invalidation of the authentication credential, an authentication credential otherwise correctly provided by an end user actor 8 to a service client 7 and forwarded to the service provider 6 may, as a result of invalidation of the authentication credential, be deemed to be incorrect, thereby resulting in validation failure upon application of the means 18 for validating the authentication credential.

In at least some implementations of the present invention, the communication between end user mobile device and the common online database may not be available in real time. In such implementations the required data saved on Common Online Database will also be saved in the end user's mobile device's local database specific to the Consumer registered the mobile device. The required data would include Consumer Card information, Merchant information, Dummy Token related to Consumer Cards and pre-defined Challenge Messages. As pre-defined Challenge Messages are used additional Challenge message will be added into the local database when communication between end user mobile device and common online database is available.

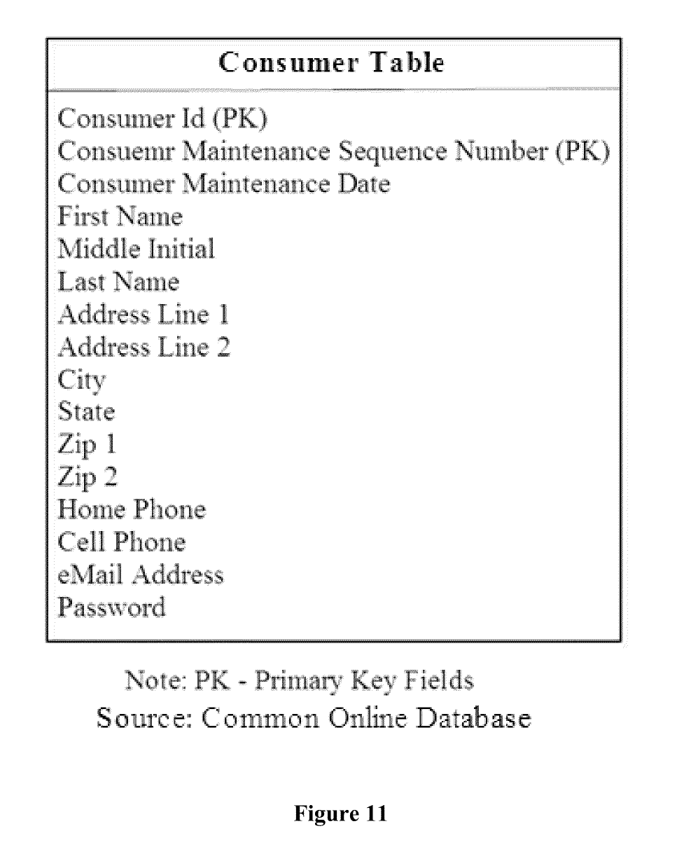

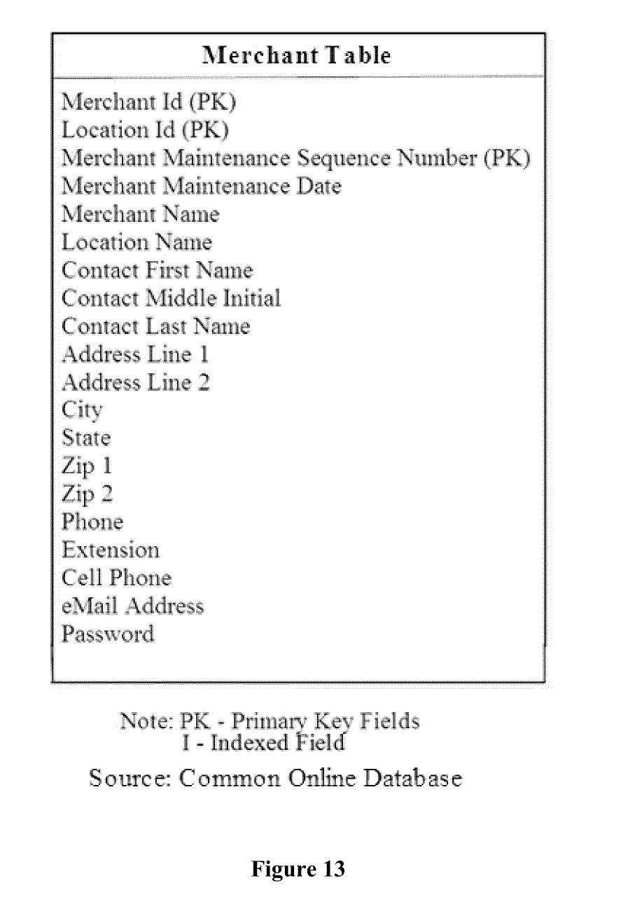

Through various embodiments of the present invention, a number of databases may be employed, including those illustrated in FIG. 11 (Consumer Table); FIG. 12 (Consumer Card Table); FIG. 13 (Merchant Table); FIG. 14 (Dummy Token Table); and FIG. 15 (Authentication Credential Table).

FIG. 16 shows, in a class diagram, a high level schema for a representative Consumer Card Table as may be implemented in connection with the exemplary hardware and software implementation of FIG. 3 using local database.

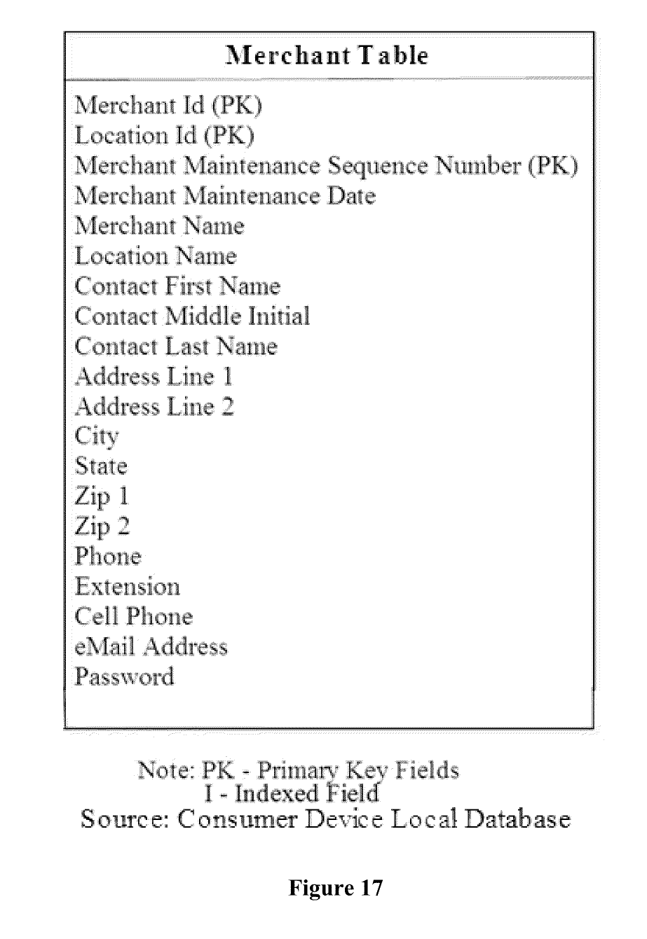

FIG. 17 shows, in a class diagram, a high level schema for a representative Merchant Table as may be implemented in connection with the exemplary hardware and software implementation of FIG. 3 using local database.

FIG. 18 shows, in a class diagram, a high level schema for a representative Dummy Token Table as may be implemented in connection with the exemplary hardware and software implementation of FIG. 3 using local database.

FIG. 19 shows, in a class diagram, a high level schema for a representative Authentication Credential Table as may be implemented in connection with the exemplary hardware and software implementation of FIG. 3 using local database.

In any case, because the scope of the present invention is, much broader than any particular embodiment, the foregoing detailed description should not be construed as a limitation of the scope of the present invention, which is limited only by the claim appended hereto.

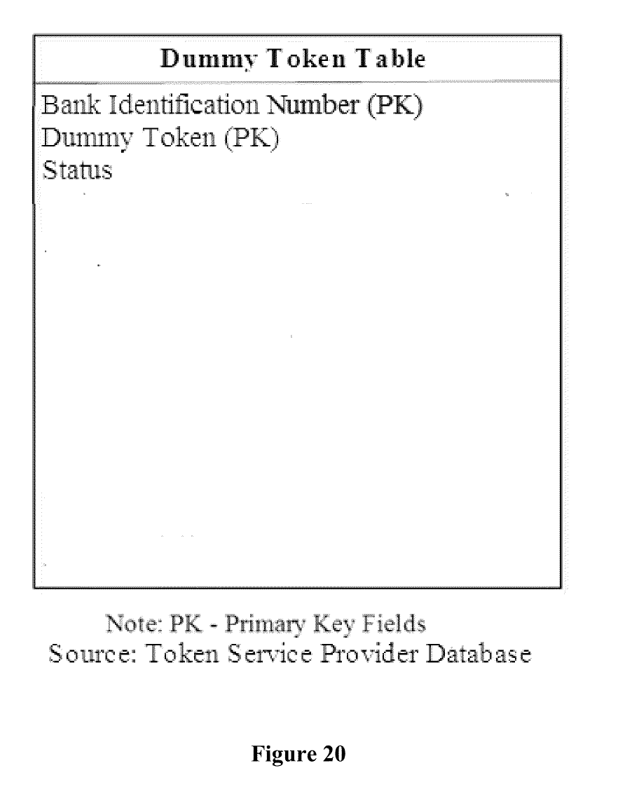

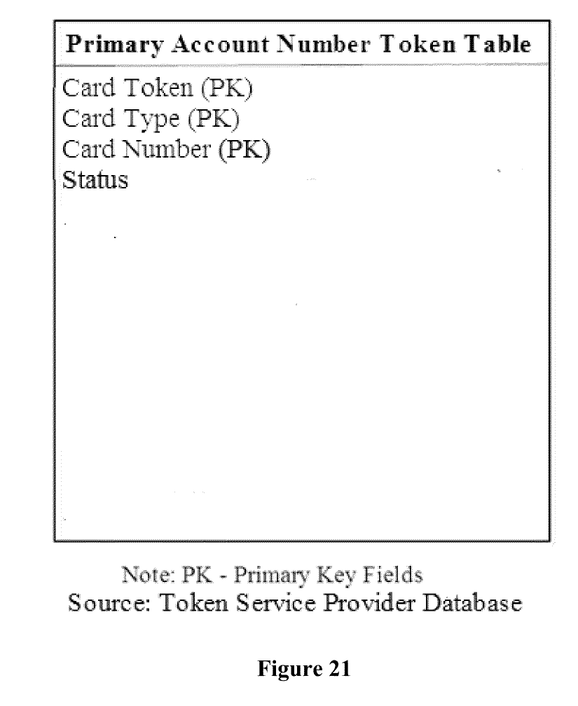

Through various embodiments of the present invention, a number of databases may be employed, including those illustrated in FIG. 20 (Dummy Token Table); and FIG. 21 (Primary Account Number Token Table).

In at least some implementations of the present invention, the token service provider can be the card issuer.

In at least some implementations of the present invention, the token service provider can be the card network.

In at least some implementations of the present invention, the token service provider can be the card acquirer.

In at least some implementations of the present invention, the token service provider can be the card processor.

In at least some implementations of the present invention, the token service provider can be an independent entity.

In at least some implementations of the present invention, the token service provider can be the card holder service provider.

In at least some implementations of the present invention, the token requestor can be the card holder service provider.

In at least some implementations of the present invention, the transaction application can be a credit card processing system.

In at least some implementations of the present invention, the transaction application can be a check processing system.

In at least some implementations of the present invention, the challenge string can be a random string where response string would be same as challenge string.

In at least some implementations of the present invention, the challenge string can be a random string with blanks where blanks can be replaced by card holder with their own personal identification number to create response string.

In at least some implementations of the present invention, the challenge string can be biometric authentication and the response string is a result from a biometric device.

In at least some implementations of the present invention, the transaction application can include a rewards application as a resource provider.

In at least some implementations of the present invention, the transaction application can include a coupon application as a resource provider.

I claim:

1. An authentication system for authenticating the identity of a requester of access by an unauthorized service client to a secured resource, said authentication system comprising:
a requester mobile device having a computer readable medium;
a requester application stored in the computer readable medium, the requestor application being an executable computer application in a requester mobile device using a common online database as well as a mobile device local database, having a first set of instructions operable to receive from a requester purporting to be an authorized user of a secured resource a request for access by an unauthorized service client to said secured resource;
wherein said requester application having a second set of instructions to generate a challenge string or select a challenge string from previously stored challenge strings and the said challenge string adapted to provide a basis for authenticating the identity of said requester;
wherein said second set of instructions is further operable to select a dummy token from previously a plurality of stored dummy tokens and the said dummy token adopted to provide a basis for a token service provider, in determining an issuer of said secured resource;
a service user application executable with a service user interface in a service provider computer using the common online database used by said requester application, said service user interface having a third set of instructions embodied in a computer readable medium operable to receive input from the said token service provider;
wherein said requester application in contact less communication with unauthorized service client contact less a terminal having a fourth set of instructions to transmit data to said unauthorized service client contact less the terminal;
wherein said requester application having a fifth set of instructions to generate a pre-determined number of challenge strings and save in said common online database as well as in said local database and also copy a pre-determined number of dummy tokens from said common online database to said local database when communication is available for said requester application with said common online database;
wherein said first set of instructions is further operable to communicate said challenge string to said authorized user that said requester purports to be;
wherein said fourth set of instructions is further operable to transmit a response string generated by said authorized user that said requestor purports to be and said dummy token to service client terminal using contact less interface;
wherein said third set of instructions is further operable to receive an authentication credential from said token service provider, said authentication credential having been provided to said token service provider by unauthorized service client, said authentication credential having been provided to said unauthorized service client by said requester; and
wherein said third set of instructions is further operable to evaluate said authentication credential to authenticate the identity of said requester.

2. An authentication system for authenticating the identity of a requester of access by an unauthorized service client to a secured resource, said authentication system comprising:
a requester application, an executable computer application in requester mobile device using a common online database as well as a mobile device local database, having a first set of instructions operable to receive from a requester purporting to be an authorized user of a secured resource a request for access by an unauthorized service client to said secured resource;
wherein said requester application having a second set of instructions to generate a challenge string or select a challenge string from previously stored challenge strings and the said challenge string adapted to provide a basis for authenticating the identity of said requester;
a service user application, an executable computer application with a service user interface in a service provider computer using the said common online database used by said requester application, said service user interface having a third set of instructions embodied in a computer readable medium operable to receive input from the said token service provider;
wherein said requester application having a fourth set of instructions to generate a pre-determined number of challenge strings and save in said common online database as well as in said local database when communication is available for said requester application with said common online database;
wherein said first set of instructions is further operable to communicate said challenge string to said authorized user that said requester purports to be;
wherein said third set of instructions is further operable to receive a dummy token and an authentication credential from said token service provider, said dummy token and authentication credential having been provided to said token service provider by a payment gateway, said dummy token and authentication credential been provided to said payment gateway by said service provider, said authentication credential having been provided to said service provider by said unauthorized service client, said authentication credential having been provided to said unauthorized service client by said requester; and
wherein said third set of instructions is further operable to evaluate said authentication credential to authenticate the identity of said requester.
